(19) United States
(12) Patent Application Publication
(10) Pub. No.: US 2014/0366380 A1
(43) Pub. Date: Dec. 18, 2014

(54) Article For Carrying A Glide Member For Use With A Razor

(71) Applicant: The Gillette Company, Boston, MA (US)

(72) Inventor: Ian Good, Reading (GB)

(73) Assignee: The Gillette Company, Boston, MA (US)

(21) Appl. No.: 14/193,760

(22) Filed: Feb. 28, 2014

Related U.S. Application Data
(60) Provisional application No. 61/835,804, filed on Jun. 17, 2013.

(51) Int. Cl. B26B 21/44

(52) U.S. Cl. CPC B26B 21/443
USPC 30/41

(57) ABSTRACT

A razor having a removable carrier for attaching one or more glide members which fits between the razor handle and cartridge head.

### BACKGROUND OF THE INVENTION

Shaving razors having large soap substrates surrounding a part or the periphery of the razor cartridge head are known. See e.g. U.S. Pat. Nos. 7,811,553; 7,877,879; U.S. Patent Publ. No. 2008/0250646, 2006/0225285, 2006/080837, 2005/0011073, and 2005/0278954. Several of these razors have also been sold on the market, including but not limited to the Gillette Venus Breeze and Venus & Olay razors, as well as the Schick Intuition razors.

These razors typically include one or more soap components which deliver lubrication to the user during shaving. In some executions, the soap components are carried by a soap substrate carrier which attached to the razor cartridge. For example, the razor described in U.S. Pat. No. 7,811,553 has a soap substrate carrier which surrounds the exterior of the razor housing and is attached via multiple retaining clips. The razor is shown with the cartridge head which attaches to a connecting member which in turn attaches to a razor handle. The soap substrate carrier is attached to the cartridge via clips such that they remain affixed even when the cartridge and connecting member are detached from the handle, and when the cartridge head is detached from the connecting member. In effect, the soap substrate remains attached to the cartridge head throughout use and disposal.

Other razors include a soap substrates which is cast onto a plastic housing which is connected to both the cartridge and the razor handle, such as for the razor described in U.S. 2005/0011073. In this razor, the soap carrier attaches to a razor cartridge and has a base which includes features which allow the carrier and cartridge to mechanical attach directly to the razor assembly (handle). To remove the cartridge, a user would actuate the mechanical attachment and release the soap carrier from the handle.

Attaching, removing, or replacing the soap substrate to the razor cartridge or to the larger razor overall can be difficult, especially considering there are razor blades on the razor cartridge. As such, there remains a need for a razor design which includes a removable soap substrate which can be attached or removed by the user with ease and allow the user the added flexibility to easily change either the soap carrier or cartridge together or separately with ease.

### SUMMARY OF THE INVENTION

One aspect of this invention relates to an article for use with a razor, comprising: a carrier forming a planar surface and at least one clearance region, said carrier forming a frontal contact surface at one side of said planar surface and a rear contact surface on the opposing side of said planar surface, wherein said clearance region forms a passage way from said frontal contact surface through said carrier out to said rear contact surface, said carrier forming at least a first glide member retaining structure; a first glide member attached to said carrier forming a skin contacting contact surface, wherein said skin contacting surface is on the same side of said carrier as said frontal contact surface. Said clearance region suitable to allow for a handle to dock onto the housing of a razor cartridge head unit.

Another aspect of the invention provides for a kit comprising a plurality of said articles which can be packaged with razor heads, optionally with one or more razor handles.

### BRIEF DESCRIPTION OF THE DRAWINGS

FIGS. 1a and 1b are rear planar views of a razor in accordance with at least one embodiment of the present invention. FIG. 1c is a side profile view of the razor of FIGS. 1a and 1b.

FIGS. 2a and 2b are rear planar views of two glide member carriers which are in accordance with at least one embodiment of the present invention.

FIGS. 3a, 3b and 3c are rear angled views of another razor in accordance with at least one embodiment of the present invention. FIG. 3d shows a frontal angled view of a carrier with glide members being attached.

FIGS. 4a and 4b are side views of a razor in accordance with at least one embodiment of the present invention.

FIG. 5 is a frontal view of a razor in accordance with at least one embodiment of the present invention.

FIGS. 6a-6c are side views of a razor in accordance with at least one embodiment of the present invention.

FIGS. 7a-7c are side views of a razor in accordance with at least one embodiment of the present invention.

FIGS. 8a-8b are side views of a razor in accordance with at least one embodiment of the present invention.

FIGS. 9a-9c are side views of a razor in accordance with at least one embodiment of the present invention.

FIGS. 10a-10b are side views of a razor in accordance with at least one embodiment of the present invention.

FIG. 11 is a frontal view of a razor in accordance with at least one embodiment of the present invention.

FIGS. 12a-12c are side views of a razor in accordance with at least one embodiment of the present invention.

### DETAILED DESCRIPTION OF THE INVENTION

I. Razor Details

a. Glide Member Carrier

The present invention relates to an article for use with a razor, comprising: a carrier forming a planar surface and at least one clearance region through which a razor cartridge and razor handle can be connected, said carrier forming a frontal contact surface at one side of said planar surface and a rear contact surface on the opposing side of said planar surface, said carrier forming at least one glide member, such as a first glide member retaining structure and a second glide member retaining structure. The first glide member retaining structure and the second glide member retaining structure can be integrally formed of the same overall structure, or they can be separate and attached to one another. A first glide member and a second glide member are each attached said carrier via their respective glide member retaining structures. Each glide member has a skin contacting contact surface, and a plane drawn between these two surfaces forms the glide member skin contacting plane. Said skin contacting surface faces the same side of said carrier as said frontal contact surface. Those of skill in the art will understand that as the razor cartridge is passed along a portion of skin, the glide members will contact the skin as well as the cartridge blades and other features present on the skin contacting surface of the cartridge head. This forms the broader skin contacting surface. At rest, the skin contacting surface of the cartridge heads can be flush with the glide member skin contacting surface, or can be positioned positive (forward toward the user) or negative (away from the user).

The clearance region can be an aperture or a passage way for another structure to extend from the rear contact surface through to a structure on the frontal contact surface, or vice versa. In one embodiment the glide member carrier is used on a razor comprising a razor cartridge and a razor handle. The glide member carrier is preferably attached or otherwise restrained between the razor cartridge and the handle. The razor cartridge comprises a docking surface positioned opposite a shaving surface which is partially defined by one or more blades present on the cartridge. The docking surface, like on other replaceable razors systems is designed to be attached to the razor handle via a docking system and the docking surface. In one embodiment, the carrier is restrained between the handle and the cartridge by the opposing forces with the docking surface of the cartridge pushing on the frontal surface of the carrier and the handle/docking system pushing on the rear surface of the carrier. In effect, the carrier can be sandwiched between the handle and cartridge and is held in place by the pressure formed between these two structures.

In one embodiment, the carrier further comprises one or more alignment members which are used to orient the carrier with either the docking surface of the carrier, the docking system of the handle, or both. For example, in one embodiment, the carrier can include a receiving hole with the docking surface forming an alignment pin which would mate into the receiving hole when the carrier and cartridge are placed adjacent to one another. The male member can also be provided on the carrier with the receiving hole on the carrier. Similar features can be used on the interface between the rear surface of the carrier and the docking system. In some embodiments, alignment features are used on both interfaces between these three structures.

In one embodiment, the carrier is free of any cartridge retaining features, free of any handle retaining features, or free of both cartridge and handle retaining features. This is an important feature as it allows the carrier to float freely as a separate stand alone structure that can easily be removed by the user when the handle and cartridge are undocked. This is in notable contrast to other executions which typically retain their shave aid carriers or holders directly to the cartridge (such as in US Patent Publ. No 2008/0250646 and U.S. Pat. No. 7,811,553) as well as different from razors where the carrier/holder is attached directly to the handle or a portion of the handle. Typical means of attachment which have been discussed include tabs, flanges, hooks, anchors, clips and the like. Without intending to be bound by theory, it is believed that being free of mechanical and/or other permanent thermal or adhesive bonds to the cartridge housing and/or, the handle docking portion, allow the carrier to be readily changeable anytime the cartridge and corresponding handle are undocked, without need to unclip or otherwise apply force by hand to remove the carrier from a device that can include small easily breakable plastic parts as well as chemistry and blades.

In one embodiment, the docking system can be attached directly to the cartridge with or without the glide member carrier layered there-between. This added flexibility allows for the same razor system to be used along with the glide member carrier or without the glide member carrier without need for excessive restructuring of the device. This can allow for manufacturing flexibility as well as allow for user flexibility depending on their specific shaving needs. Importantly, this can allow a user to decide for themself whether they want to use the added features provided on the carrier for a given shave. This added flexibility provides users with a single razor which can be used in various shaving conditions. For example where the user wants added lubrication and glide, such as where they do not have a shave preparation available, they can attach the glide member carrier to the razor. Where the user desires a razor cartridge in a smaller shaving head configuration, such as where they are shaving smaller or tighter areas, can shave with the glide member carrier removed. Without intending to be bound by theory, it is believed that users may find the present carrier particularly useful if shaving without shaving preparation as the glide members can provide extra lubrication to the skin. Additionally, the user may decide to include the carrier when shaving larger portions of skin such as the body, arms, or legs. Where the user wants to shave tighter areas, they can remove the carrier in the same session and access smaller regions or regions that have intricate curves or tight spots. The component nature of the present device allows a single razor to easily and quickly be modified by the user to suit different usage conditions.

In one embodiment, the docking system of the handle attaches to the razor cartridge via one more pins which may protrude outwardly and be pinchably attached into corresponding pin receiving members positioned at the docking surface of the cartridge, said pin receiving members forming opposing openings to receive and retain the pins. An example of this can be the docking system described and shown in U.S. Patent Application No. 2011/0067245 to Bridges et al. Other similar docking systems include those commercially available on the Gillette Atra razor system and the Gillette Mach 3 razor. In one embodiment, the pins and pin receiving members attach through one or more clearance regions formed in the carrier.

In one embodiment, the first glide member has a generally rounded shape. The portion of the glide member which contacts skin can be generally flat shaped with rounded edges to allow for improved feel. The skin contact surface can be smooth or include various forms of surface treatments, such as embossments, texturing, raised or depressed dimples, and so forth. In one embodiment, the first glide member has a different shape or surface treatment than the second glide member. Where multiple glide members are provided, they can have similar coloring, scent, shape and/or composition, or they can differ on one or more of these features.

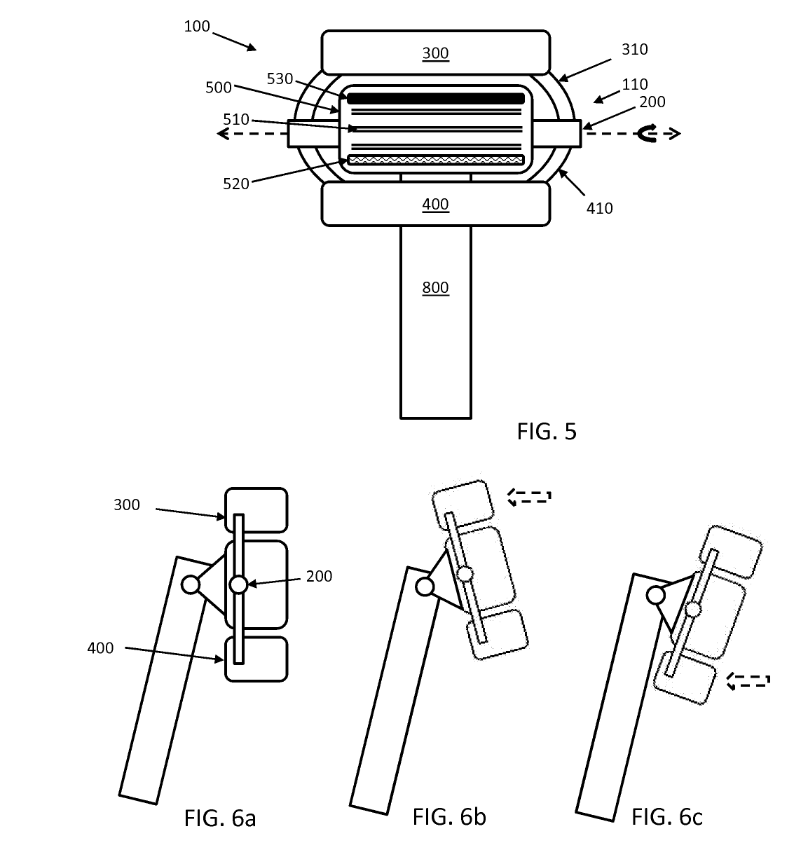

In one embodiment, a transverse longitudinal centerline formed in said carrier cutting said carrier in half can form an upper carrier region and a lower carrier region, wherein said upper carrier region is symmetrical to said lower carrier region. In some embodiments, such as shown in FIGS. 5-12, where the carrier has a single pivot axis, the single pivot axis and transverse longitudinal centerline can be the same line. In other embodiments, the glide members have separate pivots similar to the separate pivot axes shown in U.S. Pat. No. 7,811,553.

b. Kit Comprising a Plurality of Glide Member Carriers

Another embodiment of the present invention provides for a kit comprising a plurality of glide member carriers as described above. The glide member carriers can be the same or different, such as different glide member(s). In one embodiment, the kit comprises one or more razor cartridges provided along with the glide member carriers. Each razor cartridge can be paired with a glide member carrier and packaged together within the kit. In another embodiment, the glide member carriers are individually packaged in bags or tubs, with or without respective razor cartridges. In one embodiment, the kit further comprises a fully assembled razor (comprising handle, carrier, and cartridge) along with one or more of said glide member carriers and any additional razor cartridges.

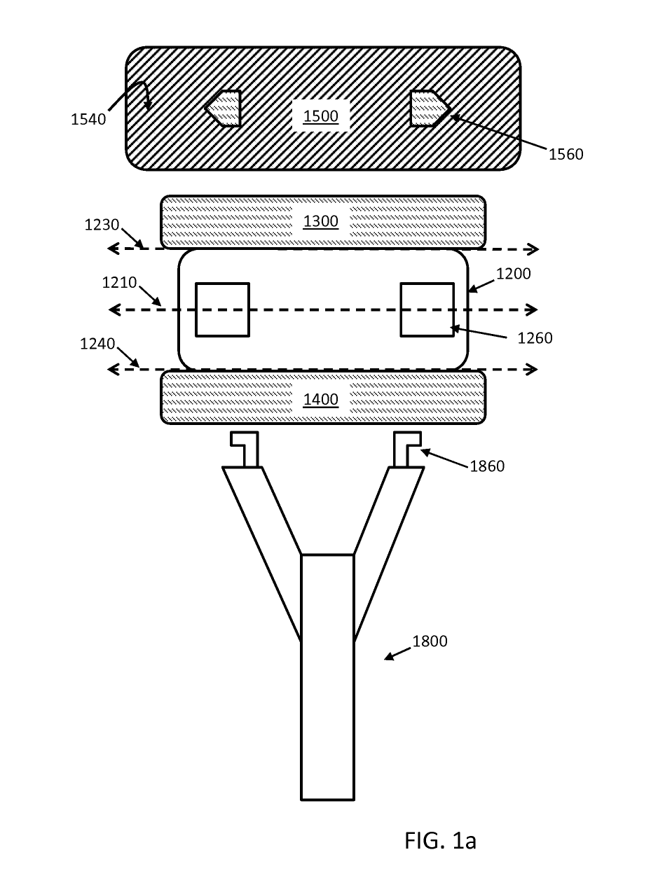

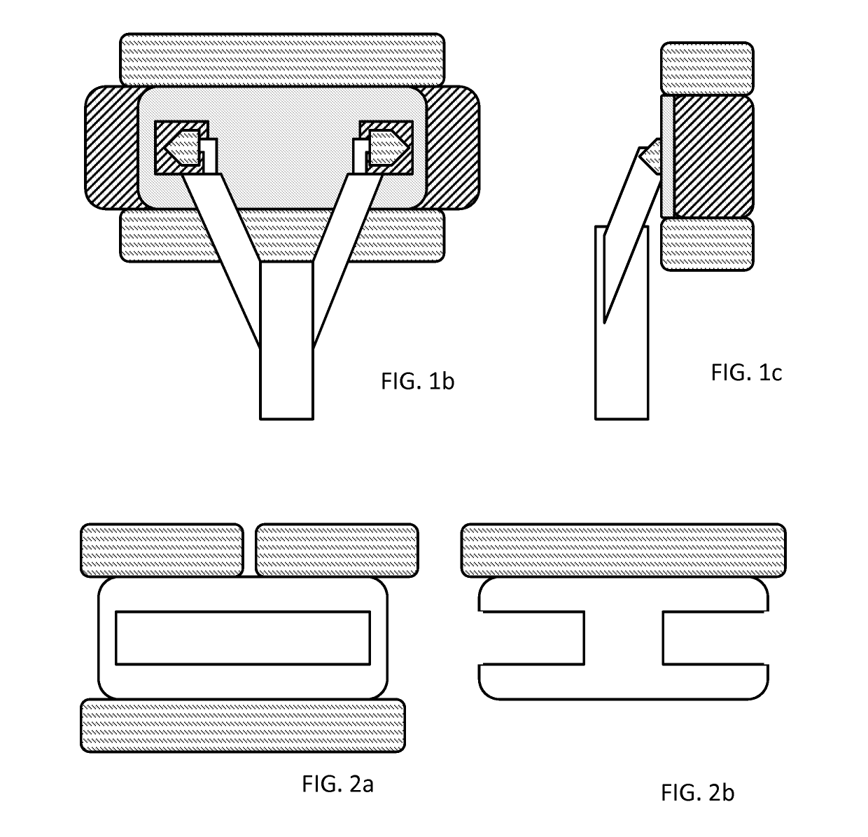

FIG. 1a is a rear planar view of a razor of the present invention where the razor handle 1800 detached from a carrier 1200 comprising a first glide member 1300 and a second glide member 1400, said carrier forming a clearance region 1260 which is shown in this embodiment as two apertures positioned on far ends of the housing where the docking system of the handle comprising pins 1860 can dock onto the razor cartridge 1500 via a pair of pin receiving members 1560 extending outwards from the docking surface 1540 of said cartridge. A single clearance region can also be used. Also shown in FIG. 1a is the embodiment where a single pivot 1210 can be provided at the transverse centerline of the carrier. As shown here, the carrier can be generally identical across the two portions of the carrier separated by the transverse centerline. This would allow the user to rotate the carrier 180 degrees. Also shown would be where each glide member includes its own pivot 1230 and 1240. FIG. 1b shows the same razor components in an assembled configuration. FIG. 1c is a side profile view of the razor of FIGS. 1a and 1b. Preferably, the portion of the glide member(s) which contacts skin is generally flush with the skin contacting surface of the cartridge head. Also shown in FIG. 1c is an embodiment where the pin receiving members protrude through said clearance region formed in the carrier. Also within the scope of the invention would be where the docking system protrudes through the carrier to attach into receiving structures formed in the cartridge.

FIGS. 2a and 2b are rear planar views of two glide member carriers which are in accordance with at least one embodiment of the present invention. FIG. 2a shows two glide members which are different in shape. The first glide member is shown here formed of two separate members. Also shown in this figure is a clearance region in the form of a single aperture which can still allow one or more docking attachments to allow the handle and cartridge to be attached. FIG. 2b shows an embodiment with just a single glide member. The glide member can be forward or aft of the region which would hold the blades.

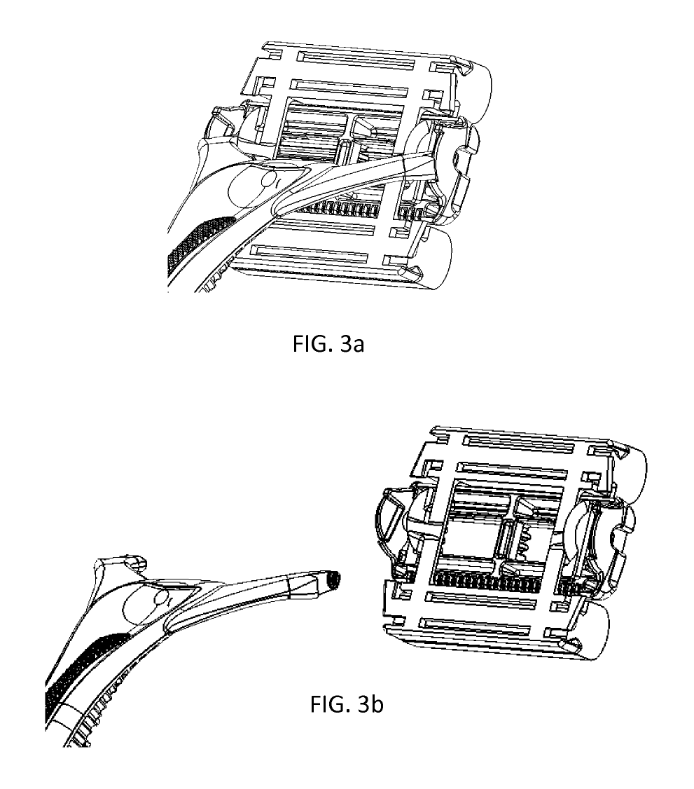

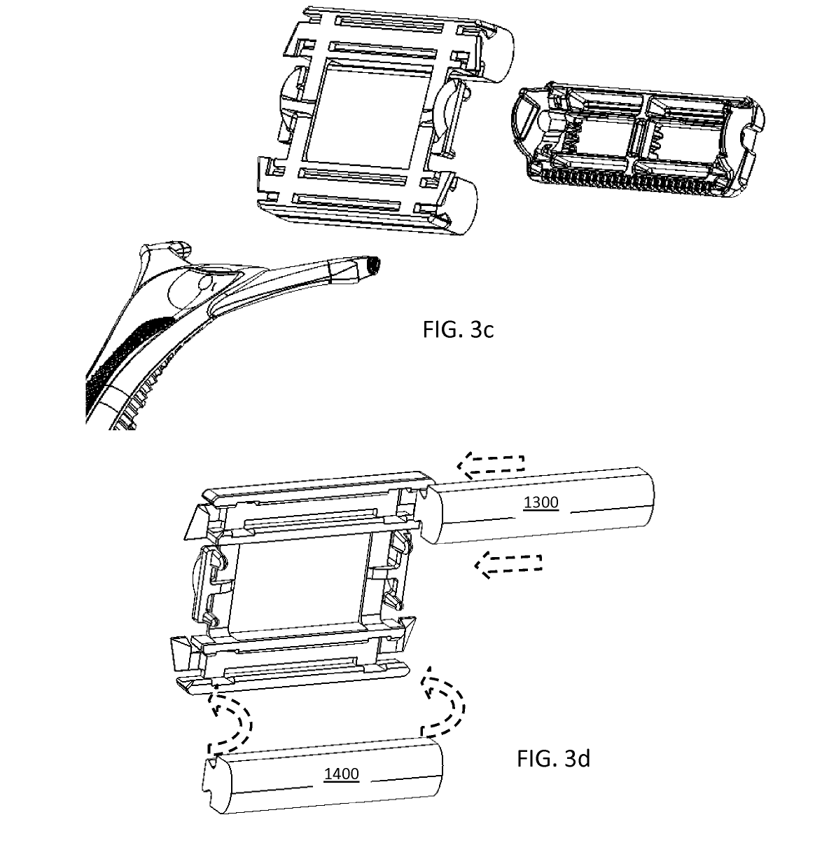

FIGS. 3a, 3b and 3c are rear angled views of another razor in accordance with at least one embodiment of the present invention. FIG. 3a shows a razor handle, carrier comprising two glide members, and a razor cartridge (with blades shown) in an assembled orientation. FIG. 3b shows the handle removed with blades removed from the cartridge head to facilitate viability. FIG. 3c shows each of these three components separated. Shown here, the docking system comprises a pair of outwardly protruding pins which dock into two receiving members formed in the cartridge. These receiving members are shown having arcoidal shape which allows the cartridge to smoothly rotate about a pivot axis formed by the opposing pins. In this embodiment, the carrier comprises corresponding arcoidal rotation embers to facilitate cartridge rotation.

FIG. 3d shows a frontal angled view of a carrier with glide members being attached. Glide member 1300 is shown being slide on from the left portion of the receiving member to the right portion. Glide member 1400 is shown being snap fitted or press fitted on. Those of skill in the art will appreciate that when press fitting the glide member on, it can be done in a rocking movement where one portion of the glide member can be placed into the receiving region, then pressure applied to the other portion. This can be done from side to side (i.e. push the left side in, then apply pressure to the right side, or vice versa), or top to bottom.

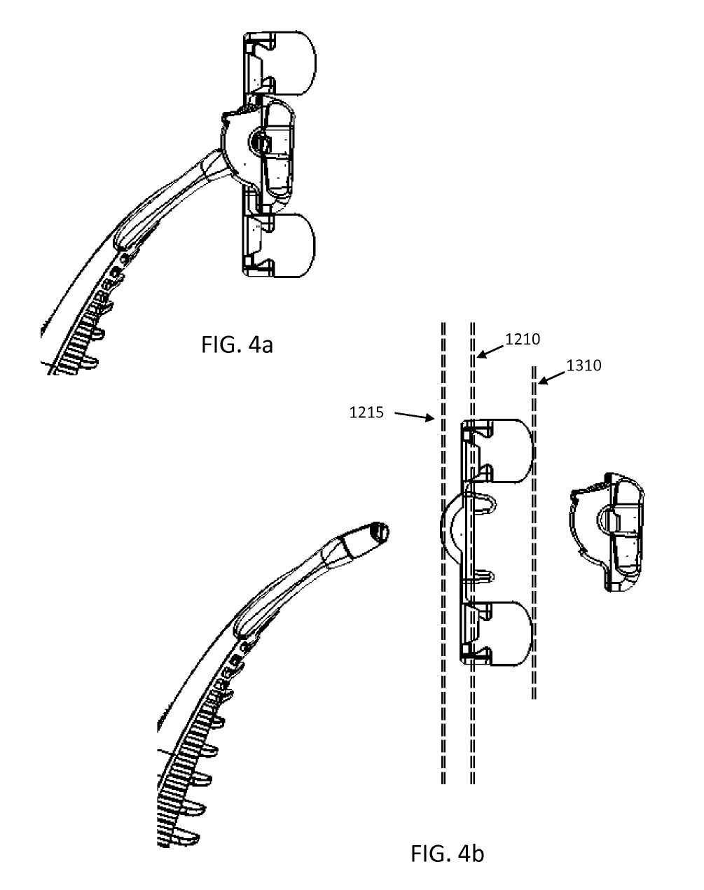

FIGS. 4a and 4b are side views of a razor shown in FIG. 3. FIG. 4a shows the razor assembled, FIG. 4b shows the handle, carrier and cartridge detached. Carrier has a frontal contact surface 1210 which faces the cartridge and a rear contact surface 1215 which faces the handle. Those of skill in the art will appreciate that the carrier need not be perfectly flat, such as shown here where the carrier forms two arcoidal rotation members which are the places where locations where the carrier contacts the handle. Also shown here is a glide member skin contacting surface formed by said first glide member. In this embodiment, where a first glide member and a second glide member are provided, they both form the same glide member skin contacting surface. The razor cartridge forms a portion of the broader skin contacting surface which can sit behind (a negative position) the skin contacting surface formed by the glide member(s), but can also be planar, or protrude outward (a positive position) from said skin contact surface formed by the glide member(s). Those of skill in the art will understand that the carrier can deflect forward toward the user or backward if pressure were applied. As such, it is possible that during use, pressure applied to the glide members can drive them backwards towards the handle and create a flatter overall skin contacting surface. Those of skill in the art will also appreciate that skin is elastic in nature and the body has many concave and convex curves. As such, the skin can adapt to engage the broader skin contacting surface even if it were not completely flat.

The devices shown in FIGS. 5-12 can also be used in accordance with the present invention, in particular where the carrier of the present invention forms the first and/or second glide member retaining structures.

FIG. 5 is a frontal view of a razor in accordance with at least one embodiment of the present invention. The razor consists of a head unit which is a razor cartridge 100 attached to a handle 800. Razor cartridge 100 comprises a cartridge housing 500 which carries at least one blade 510 (in this case shown with three blades), a guard 520 positioned at the front end of the cartridge (forward of the blades) and a lubricating strip 530 (also commonly referred to as a shave aid) positioned at the rear edge of the cartridge, aft of the blades. The head unit can also comprise one or more lubrication strips; as shown in FIG. 5, having a lubrication strip positioned forward of any blade(s). Non-limiting examples of known shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057. The razor cartridge forms a shaving plane defined by how skin would contact the portion of the cartridge exposing the razor blade tips.

The head unit can be similar to blade units described in U.S. Pat. No. 5,661,907. The handle can be similar to those described in U.S. Pat. Nos. 5,855,071, 5,956,851 and/or 6,052,903. A connecting member can be provided to connect blade unit to handle and can be similar to connecting members described in U.S. Patent Publ. Nos. 2006/0080837A, and 2006/0080838A, and/or U.S. Pat. No. 8,033,023.

The razor cartridge forms a shaving surface where the blade(s) contact skin, and a docking surface opposite the shaving surface, where the razor cartridge attached directly or indirectly to said handle. In one embodiment, the razor cartridge further comprises a glide member retaining structure 110 comprising a first glide member 300 attached to the housing of the razor via at least one first glide member carrier 310. Shown here, the glide member carrier is a pair of curved first glide member retaining structures (or support arms). Those of skill in the art will appreciate that the structures can also be straight. The razor cartridge may further comprise a second glide member 400 attached to the housing of the razor via at least one second glide member carrier 410. Shown here, the carrier is a pair of curved second glide member retaining structures.

The first glide member and the second glide member are hingedly attached to the housing such that they pivot about a single pivot axis 200. The pivot axis 200 can be formed of a beam to which the glide member carrier (i.e. retaining structures) can be hingedly attached, or can be defined by a hinged connection between the first glide member and the second glide member carriers (such as a line of weakness between the carriers allowing them to fold into and away from the shaving plane). In one embodiment, the cartridge housing includes a pair of protrusions which extend sideways away from the housing from which the glide member carriers are hingedly attached (similar to the embodiment shown in FIG. 1). Although a pair of protrusions are shown, those of skill in the art will appreciate that a single protrusion, with a corresponding first glide member carrier and a second glide member carrier and cartridge housing can also be used, particularly if a retaining feature is included to attach the single protrusion with the receiving region on the housing.

The razor cartridge of the present invention may be used with a power or manual, disposable or a refillable razor system. The razor cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201.

The terms “forward” and “aft”, as used herein, define relative position between features of the blade unit (i.e., razor cartridge). A feature “forward” of the at least one blade, for example, is positioned so that the surface to be treated with by the device encounters the feature before it encounters the at least one blade. For example, if the device is being stroked in its intended cutting direction, the guard is forward of the blade(s). A feature “aft” of the blade(s) is positioned so that the surface to be treated by the device encounters the feature after it encounters the blade(s), for example if the device is stroked in its intended cutting direction, the cap is disposed aft of the blade(s).

In one embodiment, the guard on the razor has at least one elongated flexible protrusions to engage a user's skin. In one embodiment, at least one flexible protrusion comprises flexible fins generally parallel to said one or more elongated edges. In another embodiment, said at least one flexible protrusion comprises flexible fins comprises at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface).

The head unit is fixedly or removably attached to a handle. The attachment can be a direct attachment from head unit to a docking member of the handle, or the head unit can attach to an interconnect member which is then connected to the docking member of the handle. Those of skill in the art will appreciate that the design of this invention can be achieved as a structural modification to the razors shown in U.S. Pat. No. 7,811,553, or Venus Breeze type razors, with a notable changes to what is there described as the shaving aid and the shaving aid holder.

FIGS. 6a-6c are side views of a razor in accordance with at least one embodiment of the present invention. FIG. 6a shows a razor in an at rest position while 2b shows the razor having cartridge pivoting backwards where the rear portion of the cartridge (the portion forming the first glide member, and the razor cartridge cap) are deflected back towards the razor handle. FIG. 6c shows a similar razor where the cartridge pivots forward such that the front portion of the cartridge (the portion forming the second glide member and the guard) are deflected towards the razor handle. These figures show an embodiment where the glide member carriers are static and do not bend. Although pairs of glide member retaining structures are shown, each or both of the glide members can also be merely attached with single structures. In one embodiment, where single retaining structures are used, they can be used on opposing sides or both on the same side of the razor (for example, where the first glide member retaining structure is attached to said housing by a retaining structure on the left side of the razor cartridge, and the second glide member can be attached to the housing via a single retaining structure which is attached on the right side of the razor cartridge, or vice versa.

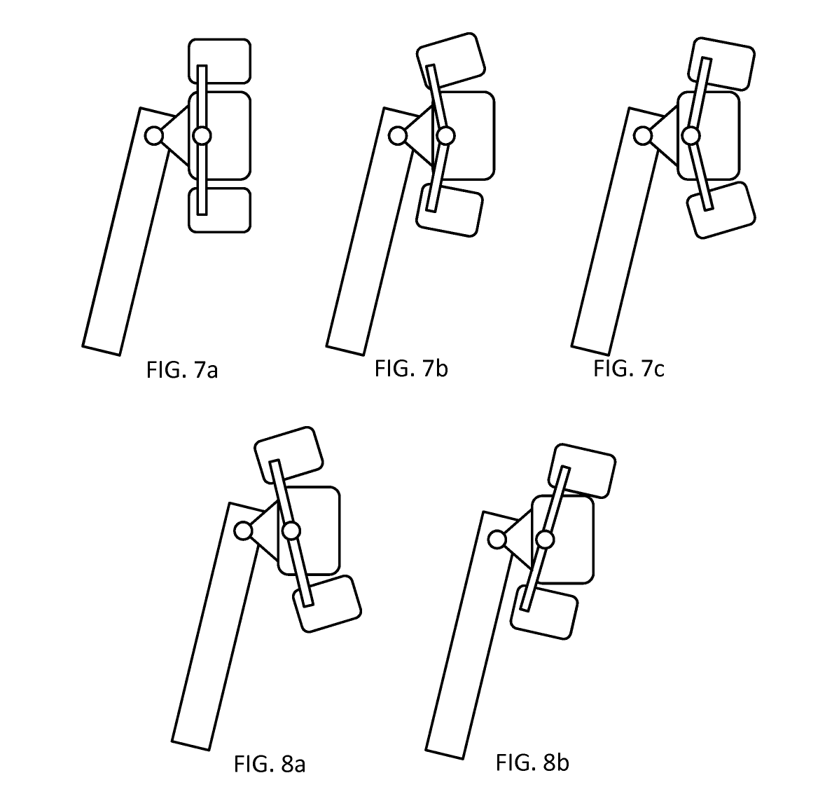

FIGS. 7a-7c are side views of a razor in accordance with at least one embodiment of the present invention. Similar to the embodiment shown in FIGS. 6a-6c, the cartridge can pivot backwards and forwards like existing cartridges. Here, the glide member retaining structures are shown pivoting along pivot axis 200 such that the glide members can deflect in backwards behind the shaving plane (FIG. 7b), and forward towards the user's skin (FIG. 7c). In one embodiment, the said first glide member carrier and said second glide member carrier form an angle of from about 165 degrees to about 195 degrees, or about 180 degrees when said razor is in an at rest position. In effect, the glide members rest at or about the shaving plane. When force is applied to the glide members, said first glide member carrier and said second glide member carrier can form a maximum deflection angle of from about 190 degrees to about 270 degrees, or from about 200 degrees to about 225 degrees, from the pivot axis (similar to a situation as shown in FIG. 7b). The razor can also have a minimum deflection angle of from about 135 degrees to about 180 degrees, or from about 150 degrees to about 175 degrees from the pivot axis (similar to a situation as shown in FIG. 7c). Those of skill in the art would appreciate that the minimum deflection angle can also be defined as the position where the glide members come into contact with another portion of the cartridge.

In one embodiment, said first glide member carrier and said second glide member carrier are biased from each other to remain in an at rest position. Those of skill in the art will appreciate that force applied by the skin during shaving can be sufficient do cause one or both glide members to deflect backwards into a position shown by FIG. 7b. The biasing force should be sufficiently low that the glide members deflect uncontrollably. Similarly, the biasing force should not be so high that the user does not need to apply excessive force which could cause discomfort or interfere with normal shaving strokes. In one embodiment, the biasing force is similar to the biasing force of the shaving aid retaining members used on Venus Breeze type razors.

FIGS. 8a-8b are side views of a razor in accordance with at least one embodiment of the present invention where the glide retaining structure is pivotably attached to said cartridge housing and pivots like a see saw such that the retaining structures. In one embodiment, the first glide member carrier and said second glide member carrier can form a fixed angle, such as from about 165 degrees to about 195 degrees, or about 180 degrees. As shown in FIGS. 8a and 8b, the first glide member carrier and the second glide member carrier can pivot together while maintaining said fixed angle.

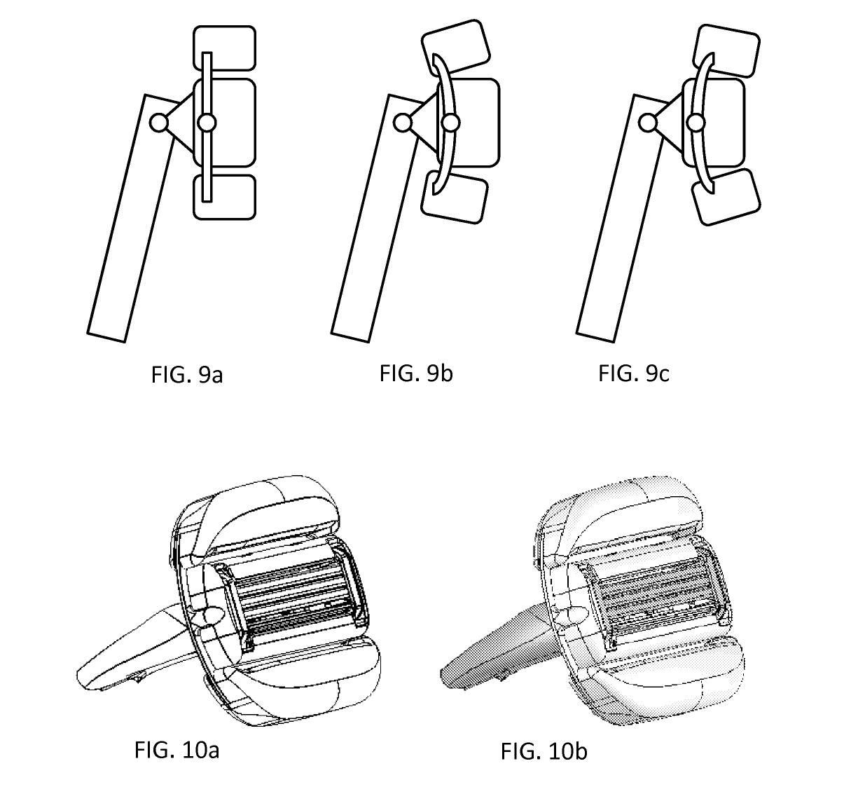

FIGS. 9a-9c are side views of a razor in accordance with at least one embodiment of the present invention, wherein one or both of the carriers are made of flexible material such that the retaining structures can bend forward and back if the rest of the carrier is in a locked position such as locked into the at rest position. In this or any other embodiment of this invention, it may be useful to allow consumers to lock the carrier from pivoting. If such an embodiment is desired, it may be useful to include flexible materials in the retaining structures such that the glide members can still deflect during use but keep the carrier in a locked position.

FIGS. 10a-10b are side views of a razor in accordance with at least one embodiment of the present invention. The cartridge shown in FIG. 10a is in black and white line drawing while 10b is shown with surface shading.

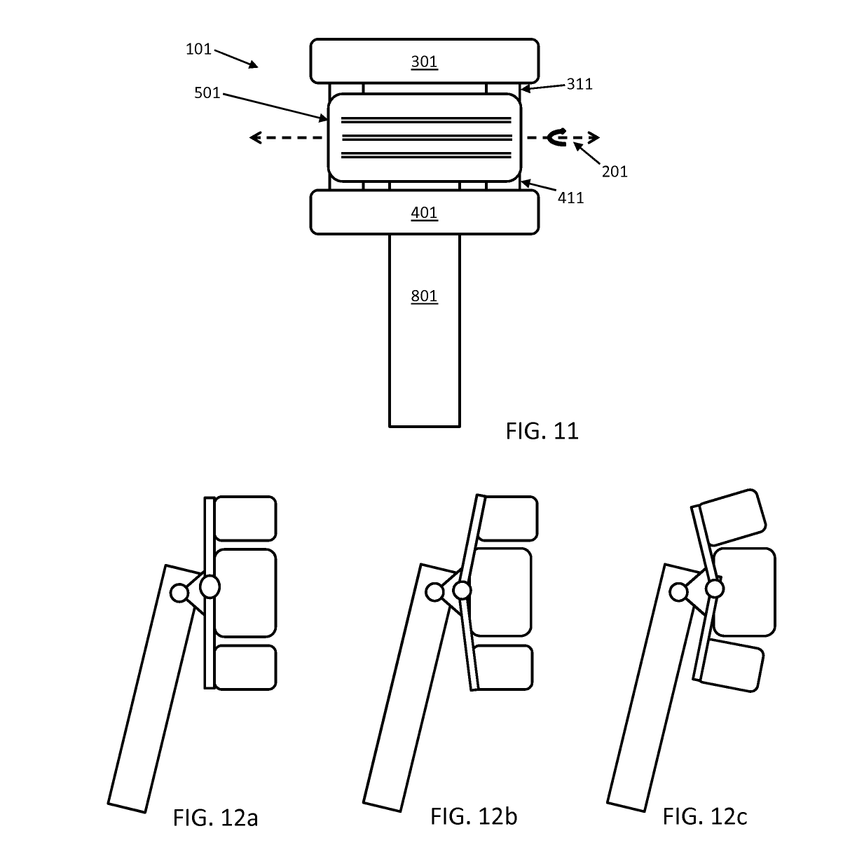

FIG. 11 is a frontal view of a razor in accordance with at least one embodiment of the present invention where the carrier does not wrap around the periphery of said cartridge housing. In this embodiment, the carrier sits behind or as part of the rearward portion of the cartridge housing, away from the shaving plane. FIGS. 12a-12c are side views of a razor in accordance with at least one embodiment of the present invention where the glide members pivot backwards (12b) and forward (12c).

In one embodiment, the glide member retaining structure 110 or one of the retaining structures may be mounted so that it is removable from the cartridge body by the consumer (e.g., if the consumer wishes to add a shaving aid holder to a cartridge that does not include one), or, alternatively, may be permanently mounted on the cartridge body or integrally molded with the cartridge body. In one embodiment, the retaining structure 110 removably attaches to the cartridge by engagement of one or more clips onto the back surface of the housing of the head unit. The glide member carrier may be engaged with the housing by sliding the housing under clips and then deflecting clips to snap them in place as explained in U.S. Pat. No. 7,811,553.

In one embodiment, the glide member and the carrier are integrally formed (meaning they are formed in the same process, such as where they are both cast together in a single mold). In an embodiment where they are not integrally formed, the glide member can be attached to said glide member via a mechanical attachment, such as where the glide member is molded or otherwise fitted around a retaining portion of the carrier, or they can be bonded via adhesive or heat. The portion of the carrier which attaches to the glide member can be similar to that used on the Venus Breeze® line of 2-in-1 razor, and/or the Schick® Intuition® line of razors. In another embodiment, the shaving aid and shaving aid holder can be similar to those disclosed U.S. Patent Publ. Nos. 2006/225285A and 2006/080837A, and/or U.S. Pat. No. 7,811,553.

In some embodiments, hinges connecting the first glide member carrier to the pivot axis and/or the second glide member carrier, are formed of an elastomeric material, e.g., a block copolymer. The elastomeric material is generally selected to provide a soft flex, so that the glide members deflect readily upon contact with the user's skin, while also providing a good spring return to the wings. For example, the elastomeric material may have a flexural modulus of about 100 to 300 psi.

II. Gliding Member

a. Non-Wearable Gliding Member

In one embodiment, the glide member can be made of a non-wearing material which is slippery when wetted. Examples of suitable non-wearing materials include metal, glass, and hard plastics, or can include coatings to enhance slipperiness such as Teflon or ceramic coatings. In one embodiment, the non-wearable gliding member can be made of a polyoxymethylene, PVC, or another commercially available hard plastic material which does not have a high coefficient of friction when contacted against skin in a wet or dry situation.

b. Conventional Shaving Aid

Where the gliding member is a shaving aid which dissolves or wears down during use to deliver chemical lubricants, the shaving aid composition can be formed by first obtaining (e.g., making) a soap base, e.g., an extruded soap base or a poured soap base. Process-sensitive ingredients, which can include pyrithione sources, can be incorporated into the soap base to form a shaving aid composition. In some instances, however, the pyrithione source can be selected and formed such that is can be added at any point during the making of the shaving aid composition or soap base. Generally, if the soap base is a poured soap base, this is achieved by melting the poured soap base, adding any process-sensitive ingredients, and then cooling the resultant composition, for example, by placing into a mold and cooling the composition, within a period of time in which the process-sensitive ingredients remain substantially non-degraded, e.g., within about 1 hour. Where the soap base is an extruded soap base, the soap base and the process-sensitive ingredients are combined by milling, grinding, and/or other mixing techniques, refined, and extruded to form a shaving aid composition. Additionally, a good quality shaving aid composition can be achieved by avoiding remelting of the process-sensitive ingredients.

One or both of the shaving aid portions are formed of the molded shaving aid composition described herein, while one of the shaving aid portions can optionally include a different or additional composition. For example the front shaving aid portion may include the molded shaving aid composition, while the rear portion may include skin soothing and conditioning ingredients such as emollients and moisturizers in place of or in addition to the shaving aid portion.

The shaving aid portions are mounted so that they will resiliently deflect upon contact with the skin, from a normal, undeflected position to a flexed position. This deflection allows the razor to be easily used in hard to reach or confined areas, such as the arm pit (axilla) or behind the knee. Deflection of the shaving aid portion also prevents premature wear of the shaving aid portion and discomfort to the user in cases where the user applies excessive pressure during shaving. In one embodiment, the angle of deflection is at least about 10 degrees, e.g., from about 10 to 60 degrees, typically about 20 to 40 degrees. Angle A is measured by drawing a line from a pivot axis 200 to the highest point of the glide member when the device is in an at rest position, and measuring the angle between this line when the glide member is in the at rest position vs. when the glide member is deflected to its design limit.

The polyoxyethylene can have a molecular weight of from about 100,000 to about 5,000,000. The shaving aid composition can further include a silicone polymer (e.g., from about 0.25 wt % to about 5 wt % silicone polymer). The shaving aid composition can further include a polyethylene, polybutene, and mineral oil composition. The composition can include from about 0.25 wt % to about 5 wt % silicone polymer, from about 10 wt % to about 60 wt % fatty acid salts, from about 0.1 wt % to about 8 wt % esters, from about 0.25 wt % to about 10 wt % polyoxyethylene and from about 0.3 wt % to about 10 wt % of a polyethylene, polybutene and mineral oil composition. The soap base can be a poured soap base, an extruded soap base, or a combination thereof.

Optional wear enhancing ingredients can increase the wear resistance of the shaving aid composition (as compared with a shaving aid composition lacking the wear enhancing ingredients), such that the shaving aid composition lasts through a greater number of shaves and/or so that the shaving aid composition does not rapidly dissolve or disintegrate in the presence of water. Many wear enhancing ingredients are process-sensitive. Many other desirable ingredients, for example, moisturizers, fragrances, and the like, may similarly be process-sensitive. Methods are provided that allow for the incorporation of such process-sensitive ingredients into a molded soap-based shaving aid composition.

i. Soap Base

The shaving aid composition includes a soap base, e.g., a poured soap base or an extruded soap base. The basic component of the soap base can be a vegetable oil or tallow, saponified or neutralized to form the base, or can be a synthetic poured soap base. Super-fatted materials containing portions (e.g., greater than about 25 weight percent) of coconut acid or other fatty acids may also be used. In some embodiments, the shaving aid composition includes a base comprising a vegetable oil or a tallow or the like, or a combination of the foregoing materials, which is saponified or neutralized. The saponification or neutralization of the vegetable oil or tallow results in the production of glycerol and salts of fatty acids to form the base. The shaving aid composition can include about 50 wt % to about 100 wt % saponified or neutralized base (e.g., about 75 wt % to about 100 wt % saponified or neutralized base), which may be opaque, translucent, or transparent. Exemplary salts of fatty acids that may be produced include sodium carboxylate salts having up to about 22 carbon atoms.

The soap base can be a synthetic soap base. In certain embodiments, the synthetic soap base includes a glycol (e.g., dipropylene glycol, propylene glycol, tripropylene glycol, and/or methylpropane diol glycol), glycerin, fatty acid salts (e.g., sodium stearate and/or potassium stearate), C15-C25 alcohols (e.g., behenyl alcohol, stearyl alcohol, cetyl alcohol, and/or myristic alcohol), steareth (e.g., a steareth 21 such as, for example, Brij®-721), stearic acid, microcrystalline wax (e.g., microcrystalline wax SP 16, SP 19, SP 16, SP 18, SP-1674, SP 16W, SP 60W, SP 89, Multiwax 180M, X-145, W-445, and/or W-835), one or more surfactants (e.g., Tegobetaine F-50, Lonzaine®, the Mackam® family of surfactants, the Mirataine® family of surfactants, and sodium lauryl ether sulfate (“SLES”) (e.g., 25% active SLES). In some embodiments, glycerin is not included in the soap base. Glycerin can optionally be included, in part or in whole, in a process sensitive phase described in greater detail below.

The soap base can, in certain embodiments, include from about 0.5% to about 30% glycol (e.g., from about 10% to about 25% glycol or from about 12% to about 15% glycol), from about 10% to about 40% glycerin (e.g., from about 18% to about 34% glycerin or from about 18% to about 24% glycerin), from about 20% to about 40% fatty acid salt (e.g., from about 25% to about 40% fatty acid salts (e.g., stearate) or from about 30% to about 35% fatty acid salt), from about 0.1% to about 10% stearic acid (e.g., from about 2 to about 5% stearic acid), from about 0.5% to about 10% microcrystalline wax (e.g., from about 0.5% to about 5% microcrystalline wax or from about 1% to about 3% microcrystalline wax), from about 1% to about 15% betaine (e.g., from about 2% to about 10% active betaine or from about 4% to about 9% active betaine), and from about 1 to about 20% active SLES (e.g., from about 1% to about 20% active SLES or from about 10% to about 15% active SLES), all based on the weight of the poured soap base. One exemplary poured soap base prior to addition of the pyrithione source includes the following:

| | |
|---|---|
| Dipropylene glycol | 17.2% |
| Glycerin | 21.4% |
| Sodium stearate | 34.4% |
| Stearic acid (Pristerene ® 4980) | 3.7% |
| Microcrystalline wax SP 89 | 1.2% |
| Tegobetaine F-50 | 7.4% |
| SLES, 25% active | 14.7% |

In some embodiments, a combination of base and synthetic surfactants can be employed.

ii. Other Ingredients in the Shaving Aid Composition

### Pyrithione Source

In one embodiment, where the gliding member is a shaving aid, the shaving aid may comprise one or more pyrithione sources. As used herein, the pyrithione source can be a pyrithione and a pyrithione salt capable of providing antimicrobial efficacy and/or other aesthetic and shave benefits. Preferred pyrithione salts are those formed from heavy metals such as zinc, tin, cadmium, magnesium, aluminum and zirconium. Zinc salts are most preferred, especially the zinc salt of 1-hydroxy-2-pyridinethione (zinc pyridinethione, also named zinc pyrithione, ZPT). Other cations such as sodium may also be suitable. The pyrithione source may be selected from the group consisting of sodium pyrithione, zinc pyrithione, magnesium disulfide pyrithione, pyrithione acid, dipyrithione, chitosan pyrithione and combinations thereof. Preferably, it is sodium pyrithione or zinc pyrithione and more preferably, it is a zinc pyrithione (ZPT). ZPT is commercially available from various suppliers. For example, ZPT FPS available from Arch Chemical can be used. It is an aqueous dispersion comprising 48% active ZPT.

Pyrithione sources are well known in the personal cleansing art, and are described, for example, in U.S. Pat. No. 2,809,971; U.S. Pat. No. 3,236,733; U.S. Pat. No. 3,753,196; U.S. Pat. No. 3,761,418; U.S. Pat. No. 4,345,080; U.S. Pat. No. 4,323,683; U.S. Pat. No. 4,379,753; and U.S. Pat. No. 4,470,982. Descriptions about pyrithione sources in the above mentioned patents are incorporated herein by reference. The pyrithione source can be present in the shaving aid composition in an amount ranging from about 0.05%, 0.1% or 0.4% to about 0.5%, 1%, 2% or 5% by weight. Examples of such shaving aids are described in detail in U.S. Patent Publ. No. 2012/0216408A.

### Zinc Source

The shaving aid composition may additionally comprise a zinc source at a level of from about 0.01% to about 0.5%, by weight. Suitable zinc source include those zinc-containing materials described in U.S. Pat. No. 4,161,526, which can also provide discoloration inhibiting benefit. Specifically, the zinc source is selected from a group consisting of a zinc salt of an organic carboxylic zinc salt, inorganic zinc salt, zinc hydroxide, zinc oxide, and combinations thereof. In one embodiment, the zinc source is zinc carbonate and/or zinc oxide. The zinc source, for example, zinc carbonate is also known as being able to potentiate the efficacy of the pyrithione source. In one embodiment, the shaving aid comprises 0.5% zinc pyrithione, 2% sodium carbonate, and 0.1% zinc carbonate.

### Zinc Pyrithione

According to an example embodiment, the shaving aid can further comprise a pyrithione or a polyvalent metal salt of pyrithione such as a zinc salt of 1-hydroxy-2-pyridinethione (known as “zinc pyrithione” or “ZPT”).

In one embodiment, the zinc pyrithione included in soap base is dry powder zinc pyrithione in platelet particle form (“platelet ZPT”). According to example embodiments, the platelet ZPT included in the soap base composition can include particles with, for example, a median particle diameter of about 0.5 microns to about 10, alternatively about 1 to about 5 microns, and alternatively about 3 microns and a mean particle diameter of about 0.5 to about 10 microns, alternatively about 1 to about 5 microns, alternatively about 2 to about 4 microns, and alternatively about 3 microns. The platelet ZPT can also have a thickness of about 0.6 to about 15 microns, alternatively about 0.6 to about 1 micron, alternatively about 0.6 microns to about 0.8 microns, and alternatively about 0.6 microns to about 0.7 microns as shown in FIG. 1 of U.S. patent Ser. No. 13/036,889, Smith et al. filed on Feb. 28, 2011, Application Docket No. 12005. The platelet ZPT included in the shaving aid can also have a span of less than about 5, and alternatively about 1.

The shaving aid can include from about 0.01% to about 5%, by weight of the shaving aid, of platelet ZPT, alternatively from about 0.1% to about 2%, and alternatively from about 0.1% to about 1%. The platelet ZPT can be included in the shaving aid as a dry power that is, for example, dispersed with the soap ingredients. Alternatively, the platelet ZPT can be included in the shaving aid as aqueous dispersion with, for example, in the soap base.

### Additional Antibacterial Agents

The soap base can optionally further include one or more additional antibacterial agents that can serve to further enhance the antimicrobial effectiveness of the shaving aids. When present, the antimicrobial shaving aid can include from about 0.001% to about 2%, preferably from about 0.01% to about 1.5%, more preferably from about 0.1% to about 1%, by weight of the antimicrobial shaving aid. Examples of antibacterial agents that can be employed are the carbanilides, for example, triclocarban (also known as trichlorocarbanilide), triclosan, a halogenated diphenylether available as DP-300 from Ciba-Geigy, hexachlorophene, 3,4,5-tribromosalicylanilide, and salts of 2-pyridinethiol-1-oxide, salicylic acid and other organic acids. Other suitable antibacterial agents are described in detail in U.S. Pat. No. 6,488,943 (referred to as antimicrobial actives).

### pH and pH Adjusting Agents

Where ZPT is included in the glide member, the pH of the present soap base can be greater than or equal to 10.7, preferably greater than or equal to 11, 11.5, 12, 12.5, 13, and 13.5, till up to 14. Where ZPT is not included, the glide member could have a broader range of pH, such as around 7 or higher. As used herein, pH of the present composition is measured at around 25° C. using any commercially available pH meter. When the tested composition is in a solid form, it is first dissolved in distilled water to form an aqueous solution of a concentration of 10%. The pH of this aqueous solution is then tested to be representative of the soap base.

In one embodiment, the present soap base comprises a pH adjusting agent in a sufficient amount to attain the above mentioned pH. The pH adjusting agents useful for the present composition includes alkalizing agents. Suitable alkalizing agents include, for example, ammonia solution, triethanolamine, diethanolamine, monoethanolamine, potassium hydroxide, sodium hydroxide, sodium phosphate dibasic, soluble carbonate salts, ammonia solution, triethanolamine, diethanolamine, monoethanolamine, potassium hydroxide, sodium hydroxide, sodium phosphate dibasic, soluble carbonate salts and combinations thereof.

### Wear Enhancers

The shaving aid composition includes one or more wear enhancing ingredients. Suitable wear enhancing ingredients include sodium stearate, polyoxyethylene, polyethylene, esters, and silicone polymers. Many of these ingredients (e.g., esters and polyoxyethylene) are typically process-sensitive. Wear enhancing materials can also impart other qualities or characteristics to the shaving aid composition, such as, e.g., increased lubrication.

### Polyoxyethylene

One suitable wear enhancing ingredient is polyoxyethylene, which is a process-sensitive material. Polyoxyethylenes are typically characterized by their nominal, or average (number average), molecular weight. The number average molecular weight is the sum of individual molecular weights divided by the number of polymers. As is known in this field, a sample of polyoxyethylene generally includes a distribution of molecular weights such that the sample will include individual polymer molecules above and below the number average molecular weight.

Inclusion of a polyoxyethylene of any nominal molecular weight can improve the wear characteristics of the molded shaving aid composition. The polyoxyethylene can have an approximate nominal molecular weight of, for example, no less than about 100,000 daltons (e.g., no less than about 500,000, 1,000,000, 2,000,000, 3,000,000, 4,000,000, 5,000,000, 6,000,000, or no less than about 7,000,000 daltons) and/or no more than about 8,000,000 daltons (e.g., no more than about 7,000,000, 6,000,000, 5,000,000, 4,000,000, 3,000,000, 2,000,000, or no more than about 1,000,000 daltons). Optionally, two or more polyoxyethylenes having different nominal molecular weights can be employed. The polyoxyethylene can be present, for example, at a level of no less than about 0.1% (e.g., no less than about 0.25%, no less than about 0.5%, no less than about 1%, no less than about 2%, no less than about 3%, no less than about 4%, no less than about 5%, no less than about 6%, no less than about 7%, no less than about 8%, or no less than about 9%) and/or no more than about 10% (e.g., no more than about 9%, no more than about 8%, no more than about 7%, no more than about 6%, no more than about 5%, no more than about 4%, no more than about 3%, no more than about 2%, no more than about 1%, or no more than about 0.5%), based on the weight of the shaving aid composition. Exemplary polyoxyethylenes include members of the POLYOX® family of polyoxyethylenes, available from Union Carbide Corp, and ALKOX® polyoxyethylenes, available from Meisei Chemical Works, Kyoto, Japan.

### Silicone Polymers

Silicone polymers can also be employed as a wear enhancing ingredient. In particular, silicone cross-polymers may be used. Silicone cross-polymers are polymers including silicone (e.g., having a silicone-based backbone) that are capable of cross-linking (e.g., that are cross-linked). Silicone polymers, particularly silicone cross-polymers, can be present at levels of at least about 0.25% active in a solvent (e.g., at least about 0.5%, 1%, 1.5%, 2%, 2.5%, 3%, 3.5%, 4%, or at least about 4.5%) and/or at most about 5% (e.g., at most about 4.5%, 4%, 3.5%, 3%, 2.5%, 2%, 1.5%, 1%, or at most about 0.5%). In certain embodiments, the silicone cross-polymer will be present at levels of from about 0.25% to about 5%. Exemplary silicone cross-polymers include, for example, lauryl dimethicone/polyglycerin-3 cross-polymer (e.g., 30% lauryl dimethicone/polyglycerin-3 cross-polymer). Commercially available silicone cross-polymers are known and are disclosed in U.S. Pat. No. 7,811,553 at col. 6.

### Esters

Esters (for example, butters and other non-liquid esters) can be incorporated into the shaving aid composition, and can function as a wear enhancer and/or as a skin-softener. In particular, semi-solid esters may be employed and they are generally process-sensitive materials. The semi-solid esters can act as an emollient and/or as a moisturizer. Exemplary semi-solid esters include butters such as, for example, shea butter, cocoa butter, kokum butter, avocado butter, olive butter, mango butter, and mixtures thereof. Esters can be incorporated into the shaving aid composition in levels of no less than about 0.5% (e.g., no less than about 1%, 2%, 3%, 4%, 5%, 6%, or no less than about 7%) and/or no more than about 8% (e.g., no more than about 7%, 6%, 5%, 4%, 3%, 2%, or no more than about 1%).

### Polyethylene Compositions

The shaving aid composition can include one or more polyethylene compositions as wear enhancing ingredients. Generally, polyethylenes can improve the wear characteristics of the shaving aid composition, but are difficult to incorporate into the composition directly. Instead, the polyethylenes can be incorporated into a composition that is then incorporated into the shaving aid composition. For example, a composition including polyethylene, polybutene, and mineral oil (for example, sold under the trade name Covagloss by Sensient Technologies) can be employed. In some embodiments, the shaving aid composition will include no less than about 0.5% (e.g., no less than about 1%, 2%, 3%, 4%, 5%, 6%, or no less than about 7%) and/or no more than about 8% (e.g., no more than about 7%, 6%, 5%, 4%, 3%, 2%, or no more than about 1%) of a polyethylene, polybutene, and mineral oil composition.

### Moisturizer Components and Other Optional Ingredients

The shaving aid composition can further include other skin care ingredients and/or other additives. Skin care ingredients that may be added to the base to enhance the composition include, but are not limited to, surfactants (e.g., sodium isostearoyl lactylate, ammonium isostearate, DEA-myristate, alkyl glyceryl sulfonate, and laureth-16), skin care agents such as petrolatum (e.g., emollients, lubricants, humectants, moisturizing agents, and conditioners), foaming agents, hair growth inhibitors, botanical extracts, antioxidants, antimicrobials, anti-inflammatory agents, astringents, anti-irritants, depilatory agents, medicinal agents, absorbants, fragrances, coloring agents (e.g., dyes and pigments) and exfoliating agents (e.g., loofa, seaweed, oatmeal, pumice, apricot seed, and the like). Exemplary embodiments of skin care agents include, but are not limited to, humectants such as glycerin, sorbitol, and propylene glycol, skin freshening and soothing agents such as menthol, aloe, allantoin and collagen, lubricants such as polyoxyethylene, and silicones (e.g. dimethicone, dimethiconol, dimethicone copolyol, stearyl dimethicone, cetyl dimethicone copolyol, phenyl dimethicone, cyclomethicone, etc.), sodium or potassium salts (e.g., lactylates, chlorides, sulfonates, and the like), vitamins and vitamin complexes (including vitamin precursors and derivatives), cocoates, metal oxides, oils (e.g., cocoa butter), dimethicone, allantoin, sucrose cocoate, oleyl lanolate, thiourea, tocopheryl acetate, PPG-33, undeceth-3, honey, algae and aloe barbadensis. The skin care ingredients can in some embodiments be present in amount of no more than about 35% (e.g., no more than about 30%, 25%, 20%, 15%, 12%, 10%, 8%, 6%, 4%, or no more than about 2%). The absorbents can be clays or clay-based compositions, kaolin, wood powder, sodium chloride, cyclodextrin, chalks, talcs, silicas, polytetrafluoroethylene, or the like, and can be present in amounts of no more than about 9% (e.g., no more than about 5% or no more than about 3%). Clays that may be added include bentonite, kaolin, combinations of the foregoing clays, and the like.

Exemplary coloring agents include dyes and pigments, for example, titanium dioxide, manganese violet, zinc oxide, an Ultramarine (e.g., Ultramarine Blue 4), Orange 4, Green 3, or other dyes or pigments approved for use in cosmetics, either alone or in combination. Coloring agents can in certain embodiments be added in an amount of no more than about 6% (e.g., no more than about 4%, 2%, 1%, 0.1%, 0.01%, 0.001%, 0.0001%, or even no more than about 0.00001%) and/or no less than about 0.000001% (e.g., no less than about 0.00001%, 0.0001%, 0.001%, 0.01%, 0.1%, or no less than about 1%) by weight.

Fragrances are odorants used to impart desirable smells to the composition and may further mask the less desirable odors of other components of the composition. Any fragrance approved for use in cosmetics may be employed. In certain embodiments, at least one fragrance ingredient can be added in an amount up to about 4% (e.g., up to about 2%, up to about 1.5% or up to about 1%).

An exemplary process sensitive phase includes the following:

| | |
|---|---|
| Glycerin | 62.4% |
| Shea butter | 5.4% |
| Fragrance (IFF 4473-BH) | 5.4% |
| POLYOX ® WSR coagulant (MW approximately 5 million) | 26.9% |
| D&C Red 33 Dye | 0.005% |

Wear Characteristics of the Shaving Aid

In some embodiments, the shaving aid composition exhibits good wear characteristics. Wear characteristics can be determined in a number of ways. For example, the shaving aid composition can be incorporated onto a razor, and the number of shaves before certain shaving performance characteristics begin to degrade can be determined. In other embodiments, the wear can be determined by subjecting the shaving aid composition to set abrasive conditions (e.g., a given surface composition and speed of an abrasive device such as, e.g., an abrasive wheel) and determining how much of the composition wears off in a given time period.

In some embodiments, wear resistance can be measured by maintaining a flow of water over a textured surface and between this textured surface and the shaving aid body. This process is described in U.S. Pat. No. 7,811,553 at col. 12, lines 33-56. Another wear test utilizes cartridges of shaving aid composition molded to a holder and testing the cartridge using a wet wheel apparatus. This process is described in U.S. Pat. No. 7,811,553 at col. 12, line 57—col. 13, line 13.

III. Methods of Making the Molded Shaving Aid Composition

### Multi-Step Process

In one embodiment, the shaving aid is molded and can be formed by a multi-step process, such as generally described in U.S. Pat. No. 7,811,553 at col. 8, line 60—col. 11, line 6. In short the two step process can include a first step of forming a poured soap base.

The poured soap base can be a tallow or vegetable-based soap base, a synthetic soap base, or a combination of these. In certain embodiments, the process of forming the soap base includes elevating the soap base ingredients to a temperature of no less than about 80° C. (e.g., no less than about 85° C., 90° C., 95° C., 100° C., or 105° C.). The soap base ingredients are in some embodiments subjected to these temperatures for a period of time no less than about 1 hour (e.g., no less than about 2, 3, 4, 5, 10, or no less than about 20 hours).

In a second step, a second phase is prepared, which can include one or more of the ingredients that are process-sensitive, such as certain pyrithione sources, the esters, the polyoxyethylene, fragrances, dyes, and other optional ingredients. The second phase can be prepared by warming glycerin to a temperature of from about 25° C. to about 50° C. (e.g., to about 35° C.) and adding any process-sensitive ingredients. The elevated temperature can aid in the incorporation of these ingredients, and can be selected on the basis of the particular ingredients that are being incorporated. For example, butters typically melt at about 35° C., so raising the temperature of the second phase to about 35° C. can aid in melting the butters into the phase. The selection of ingredients and amounts of the ingredients selected will vary, depending on the levels desired in the final shaving aid composition. In some embodiments, ingredients that are not themselves process-sensitive can be included in the second phase. The temperature of the second phase can in certain embodiments be maintained at from about 25° C. to about 50° C. (e.g., at about 35°) until such time as the second phase is added to the soap base. In other embodiments, the second phase can be allowed to cool (e.g., to room temperature) prior to being incorporated into the soap base.

As a third step, a shaving aid composition can be formed from the mixture of the soap phase and a second phase is illustrated in FIG. 5. A solidified poured soap base 202 is heated to a temperature of from about 90° C. to about 100° C. (e.g., to about 91° C., about 92° C., about 93° C., about 94° C., about 95° C., about 96° C., about 97° C., about 98° C., about 99° C., or about 100° C.) and remelted to form a melted soap 204. The melted soap 204 is metered via a pump 206 into a heated filler feed vessel 210 that is equipped with a stifling mechanism 212. Filler feed vessel 210 is configured to maintain the temperature of its contents at about 95° C. A second phase 220 is formed by intermixing the process-sensitive ingredients 224 in heated chamber 222. The second phase 220 is then metered via pump 228 into the filler feed vessel 210 and intermixed with the soap base 202 to form a molten shaving aid composition 230.

The molten shaving aid composition 230 is then metered via fill pumps 232 into individual molds 236 formed in a mold block 238, where the shaving aid composition is cooled to form molded shaving aid compositions 240. The temperature of the molten shaving aid composition 230 is maintained at a temperature of about 95° C. until the shaving aid composition is placed in the molds 236.

Because the molten shaving aid composition 230 can include process-sensitive ingredients 224, the molten shaving aid composition 230 is held at the elevated temperature for a period of time that is less than would result in substantial degradation of the process-sensitive ingredients 230. For example, in some embodiments, the molten shaving aid composition 230 is held at an elevated temperature for no more than about 120 minutes (including e.g., no more than about 110 minutes, no more than about 100 minutes, no more than about 90 minutes, no more than about 75 minutes, no more than about 60 minutes, no more than about 50 minutes, no more than about 40 minutes, no more than about 30 minutes, no more than about 20 minutes, no more than about 10 minutes, no more than about 5 minutes, or even no more than about 2 minutes) before it is placed into molds and cooled. In this fashion, a molded shaving aid composition can be formed in which the process sensitive ingredients are substantially non-degraded.

In certain embodiments, the shaving aid composition is placed into a mold having a shaving aid mounting device (e.g., the wings described below) already positioned in the mold. In this fashion, the shaving aid composition can embed itself into the shaving aid mounting device upon solidifying.

Once the shaving aid composition has cooled to a sufficient point (e.g., to the point that it has solidified enough to be easily separated from the mold), the shaving aid composition can be removed from the mold. In some embodiments, the shaving aid composition is allowed to cool to approximately room temperature before being removed from the mold. In other embodiments, the shaving aid composition is allowed to cool to a temperature no greater than about 80° C. (e.g., no greater than about 75° C., 70° C., 65° C., 60° C., 50° C., 40° C., no greater than about 30° C., no greater than about 25° C., no greater than about 20° C., no greater than about 15° C., no greater than about 10° C., no greater than about 5° C., or no greater than about 0° C.) before being removed from the mold.

### One-Step Batch Process

In some embodiments, the pyrithione source and any process-sensitive ingredients can be added directly to the poured soap base melt in a one-step batch process. In one such embodiment, the poured soap base melt is maintained at about 95° C., and the second phase is added to the melt to form the shaving aid composition without first cooling and then re-melting the poured soap base melt. The shaving aid composition is then placed into one or more molds and cooled. In another such embodiment, the process sensitive ingredients are mixed directly into the poured soap base melt without first being incorporated into a process sensitive phase. The resulting shaving aid composition is then placed into one or more molds and cooled. In each case, the composition is placed in molds and allowed to cool before enough time has elapsed to substantially degrade some or all of the process sensitive ingredients. In particular, the time that elapses between adding the process-sensitive ingredients to the melted soap base and placing the molten shaving aid composition into the molds and cooling the shaving aid composition should be less than an amount of time in which some or all of the process-sensitive ingredients typically would begin to degrade at the elevated temperature and shear of the intermixing step. Generally, this time will be less than about 90 minutes (e.g., less than about 80, 70, 60, 50, 40, 30, 20, 10, or less than about 5 minutes).

### Continuous Process

In some embodiments, the molded shaving aid composition is prepared in a continuous process. The ingredients for the soap base are first combined and flowed through a heated chamber to increase the temperature of the ingredients to at least about 90° C. (e.g., at least about 95° C., 100° C., 105° C., 110° C., 115° C., or at least about 120° C.). The heated chamber and pumping mechanism are configured to permit a sufficient dwell time of the soap base components at the elevated temperature to allow for sufficient melting and intermixing of the ingredients.

Next, the melt is moved into a second chamber maintained at no more than about 100° C. (e.g., no more than about 90° C., no more than about 80° C., or no more than about 70° C.). In the alternative, the melt can be retained in the first chamber, and the temperature of the first chamber can be reduced to no more than about 100° C. (e.g., no more than about 90° C., no more than about 80° C., or no more than about 70° C.). While maintaining this temperature, the process-sensitive ingredients are introduced and mixed into the soap base melt to form the shaving aid composition. The ingredients can be introduced individually, or can be introduced in the form of process sensitive phase, which is described above. The shaving aid composition is then flowed into a mold, e.g., by injection molding, and cooled to form a molded shaving aid composition.

### Extruded Soap

An extruded soap can be employed in certain embodiments. The soap base can be generally formed by combining the soap base ingredients in a reaction vessel to form a liquid soap base (e.g., by saponification or neutralization reaction) and glycerin, which is removed from the liquid soap base. The liquid soap base is moved to a drying chamber where at least some of the water is removed (e.g., by vacuum spray drying) to form substantially dry soap pellets (e.g., dry soap noodles or shavings). The dry soap pellets are then introduced into an amalgamator having one or more paddles for mixing and/or grinding the dry soap pellets along with process sensitive ingredients, which are introduced into the amalgamator, to form an extruded soap dry blend. The extruded soap dry blend can in some embodiments be macromolecularly homogenized (e.g., a substantially even distribution of the process-sensitive ingredients among the dry soap pellets can be achieved). The extruded soap dry blend is then refined, e.g., by introducing the extruded soap dry blend into one or more rolling mills to achieve a substantially uniform texture. The extruded soap dry blend is then extruded using an extruder, optionally using heat (e.g., not more than 95° C., 90° C., 85° C., 80° C., 70° C., 60° C., 50° C., 40° C., 30° C., or not more than 25° C.) and/or pressure, to form a continuous bar of extruded soap, which can be subjected to further processing steps (e.g., cutting and/or stamping into the desired final shape).

In one embodiment, the invention relates to a method of making an article comprising a step of providing a carrier forming at least one glide member retaining structure, said at least one glide member retaining structure forming a receiving member; providing a first glide member; attaching said first glide member onto said receiving member. These steps can be performed for one or more glide members, the steps can be performed concurrently for each glide member, or can be performed in series (i.e. not concurrently).

Where the glide member is formed by molding, such as via the multi-step process described above. Where the glide member is formed by extrusion, the extruded soap blend can be passed through an extrusion die to form it into a profile with interlocking member (like the dovetail) and then is left to cool and cut to an appropriate length (the soap can also be cut while warm but is more susceptible to deformation while handling). An alternative process is to extrude the soap into an intermediate form (such as a cylinder having round or “D” cross sectional shape) to form a blank or billet. The billet can then be immediately cut to length and press into a wing shape with an interlocking member while the soap is still warm. The advantage of adding the additional pressing step is that it allows a more complex and desirable form to be added to the soap than the extrusion alone.

Once molded or extruded (and optionally pressed) into shape, the glide members can be left to cool to aid handling before being slid or snapped into the glide member receiving region formed in the carrier. In another embodiment, the step of attaching the glide member can be done while the glide member is still warm. Further, it is possible to design the glide member profile so that it can more easily be slid in lengthwise along the receiving region (such as sliding it along a receiving track) or clipped or snap fit in vertically to be retained by opposing pressure applied to the retained portion of the glide member, or slid in by the direction of the shaving stroke. Various shapes can be used to allow the glide member to be retained within the retaining region.

In another embodiment, said step of providing said glide member comprises a step of cooling said glide member to room temperature before said step of attaching said glide member to said receiving member. In one embodiment, the step of providing said first glide member comprises the steps of: providing a soap feed; extruding said soap feed to form a extruded soap; cutting said extruded soap to form a first glide member; and cooling said first glide member.

A method of assembling a razor comprising the steps of: providing an article comprising: a carrier forming a planar surface and at least one clearance region, said carrier forming a frontal contact surface at one side of said planar surface and a rear contact surface on the opposing side of said planar surface, said carrier forming at least a first glide member retaining structure; a first glide member attached to said carrier forming a skin contacting contact surface, wherein said skin contacting surface is on the same side of said carrier as said frontal contact surface; providing a razor cartridge; providing a razor handle; positioning said article between said razor cartridge and said razor handle; attaching said razor handle to said razor cartridge through said at least one clearance region formed in said carrier. Said carrier need not be not fastened to said razor cartridge or said handle.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Further, as used herein, where a group is described to be “comprising of” a list of group members, that group may also “consist essentially of” or “consist of” that same list of group members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article for use with a razor, comprising:
a. a carrier forming a planar surface and at least one clearance region, said carrier forming a frontal contact surface at one side of said planar surface and a rear contact surface on the opposing side of said planar surface, said carrier forming at least a first glide member retaining structure;
b. a first glide member attached to said carrier forming a glide member skin contacting contact surface, wherein said glide member skin contacting surface is on the same side of said carrier as said frontal contact surface.

2. The article of claim 1, further comprising a second glide member attached to said carrier by a second glide member retaining member retaining structure positioned opposite from said first glide member retaining structure.

3. The article of claim 2, wherein said first and said second glide members form a glide member skin contacting surface.

4. The article of claim 2, wherein the first glide member has a different shape than the second glide member.

5. The article of claim 2, wherein the first glide member has a different compositional makeup than said second glide member.

6. The article of claim 2, further comprising a transverse longitudinal centerline forming an upper carrier region and a lower carrier region, wherein said upper carrier region is symmetrical to said lower carrier region.

7. The article of claim 2, wherein said first and said second glide member retaining structures are formed of one structure.

8. The article of claim 2, wherein both said first and second glide members pivot about a single pivot axis.

9. The article of claim 2, wherein said first glide member pivots about a first glide member pivot axis, and said second glide member pivots about a second glide member pivot axis, wherein said first and said second glide member pivot axes are not the same.

10. The article of claim 1, wherein said first glide member comprises polyoxyethylene glycol and a soap base.

11. The article of claim 1, wherein said first glide member comprises a non-wearable composition.

12. The article of claim 1, wherein said carrier is free of any additional cartridge retaining features.

13. The article of claim 1, wherein said carrier is free of any handle retaining features.

14. An article for use with a razor, consisting essentially of:
a. a carrier forming a planar surface and at least one clearance region, said carrier forming a frontal contact surface at one side of said planar surface and a rear contact surface on the opposing side of said planar surface, said carrier forming at least a first glide member retaining structure;
b. a first glide member attached to said carrier forming a glide member skin contacting contact surface, wherein said glide member skin contacting surface is on the same side of said carrier as said frontal contact surface, wherein said carrier is free of any additional cartridge retaining features and wherein said carrier is free of any handle retaining features.

15. A kit comprising a plurality of the articles of claim 1.

16. The kit of claim 15, comprising a first article and a second article, wherein at least one of the glide members of the first article is different from the glide members of the second article.

17. The kit of claim 15, further comprising a plurality of razor cartridge heads.

18. The kit of claim 15, wherein each of said articles is individually packaged.

19. The kit of claim 18, further comprising a plurality of razor cartridge heads, wherein each of said articles is paired with one of said razor cartridge heads and each pair is contained in said individual packaging.

20. The kit of claim 15, wherein at least one of said articles is attached to an assembled razor.
